(19) United States
(12) Patent Application Publication
(10) Pub. No.: US 2015/0163340 A1
(43) Pub. Date: Jun. 11, 2015

(54) PORTABLE TERMINAL AND A METHOD FOR OPERATING THE SAME

(71) Applicants: Intellectual Discovery Co., Ltd., Seoul (KR); INFOBANK CORP., Seongnam-si (KR)

(72) Inventors: Hong Suk Kang, Seoul (KR); Jong Cheol Hong, Seoul (KR); Ji Hyun Ahn, Seongnam-si (KR); Jong Min Kim, Seoul (KR)

(21) Appl. No.: 14/263,427

(22) Filed: Apr. 28, 2014

(30) Foreign Application Priority Data
Apr. 29, 2013 (KR) 10-2013-0047765

(51) Int. Cl. H04M 1/725

(52) U.S. Cl. CPC H04M 1/72563; H04M 1/72561

(57) ABSTRACT

Provided is an operating method of a portable terminal including receiving a voice signal from another party terminal, extracting a function control command from the voice signal, performing a function of the portable terminal corresponding to the function control command, generating an interface for transmitting a result of the function performance to the other party terminal, and outputting the interface when a predetermined user operation is detected.

### CROSS-REFERENCE TO RELATED APPLICATIONS

This application claims priority under 35 U.S.C. §119 to Korean Patent Application No. 10-2013-0047765, filed on Apr. 29, 2013, the disclosure of which is incorporated herein by reference in its entirety.

### TECHNICAL FIELD

The present invention relates to a portable terminal and an operating method thereof, and more particularly, to a portable terminal and an operating method thereof that can enhance user convenience through functional control based on the other party's voice.

### BACKGROUND

Recently, smartphones are becoming widespread. In general, smartphones provide a lot of various services using various sensors and a mobile communication. In particular, recently, a large number of applications using smartphones have been released.

Furthermore, as high speed mobile communication networks spread all over the country, users can make a call to talk with the other party and also communicate various information using their smartphones at any place and at any time.

As such, users may make a call to communicate various information using their smartphones.

In particular, specific information may be acquired through the call. For example, the call may be made to inquire about a phone number, current position, schedule information, and specific file of the other party, and a phone number, a name, and an address of another person.

In this case, generally, in order to provide information inquired from the other party, a user searches his/her smartphone for the information by manipulating its key button, or after completion of the call, searches for the information over the wireless Internet to deliver the information to the other party through a call, a text, or a multimedia message.

However, when a user searches his/her portable terminal for information inquired while talking on the phone, there are limitations in that the information search is not easy and also needs to take a pause because the user should manipulate a key button of the portable terminal several times.

In addition, when a user intends to search for and provide the information after completion of the call, the user may forget to search for and provide the information, thereby breaking relationship therebetween.

Furthermore, when a user manipulates his/her cell phone while driving, an accident occurrence probability increases due to attention distribution.

### SUMMARY

Accordingly, the present invention provides a terminal for recognizing a control command of another party's terminal and providing an interface for transmitting information required by the other party at an appropriate time.

The present invention also provides a terminal for generating an interface based on a control result transmitted from the other party's terminal and providing the interface at an appropriate timing such that the other party conveniently acquires information while operating an appropriate function of the terminal.

In one general aspect, an operating method of a portable terminal includes: receiving a voice signal from another party terminal; extracting a function control command from the voice signal; performing a function of the portable terminal corresponding to the function control command; generating an interface for transmitting a result of the function performance to the other party terminal; and outputting the interface when a predetermined user operation is detected.

In another general aspect, a portable terminal includes: a communication unit configured to receive a voice signal from another party terminal; a control unit configured to extract a function control command from the voice signal, perform a function of the portable terminal corresponding to the function control command, and generating an interface for transmitting a result of the function performance to the other party terminal; and a display unit configured to output the interface when a predetermined user operation is detected.

Other features and aspects will be apparent from the following detailed description, the drawings, and the claims.

### BRIEF DESCRIPTION OF THE DRAWINGS

FIG. 1 is a block diagram schematically showing a system including a portable terminal and another party terminal according to an embodiment of the present invention.

FIG. 2 is a more detailed block diagram illustrating a portable terminal according to an embodiment of the present invention.

FIG. 3 is a flowchart illustrating an operating method of a portable terminal according to an embodiment of the present invention.

FIG. 4 is a ladder diagram illustrating an operation flow between a portable terminal and another part's terminal according to an embodiment of the present invention.

FIG. 5 is a diagram illustrating a transmission interface output to a portable terminal according to an embodiment of the present invention.

FIG. 6 is a flowchart illustrating an operation of a portable terminal according to another embodiment of the present invention.

FIG. 7 is a diagram illustrating an alarm interface output to a portable terminal according to another embodiment of the present invention.

### DETAILED DESCRIPTION OF EMBODIMENTS

The following merely illustrates the principles of the invention. It will thus be appreciated that those skilled in the art will be able to devise numerous other arrangements which embody the principles of the invention and thus are within the spirit and scope of the invention. In addition, all conditional terms listed herein and understood that the embodiments is intended only for the purpose of, in principle, to understand the concept of the present invention is clearly not limited to the embodiment and state specifically enumerated.

In addition, the principles of perspective and an embodiment of the present invention, as well as to enumerate the specific embodiments is intended to include the structural and functional equivalents of these considerations, a detailed description of all is to be understood. In addition, these waters evenly currently known equivalents as well as equivalents will be developed in the future, i.e., to include all the elements to perform the same function, regardless of structure and invention should be understood.

Thus, for example, a block diagram of the present specification is to be understood to represent a conceptual point of view that embodies the principles of the present invention, an exemplary circuit. Similarly, flow diagrams, state transition, such as pseudo-code, understood to be substantially in a computer readable medium can be represented by a computer or processor has been clearly shown to represent the various processes are performed by a computer or processor, whether or not should be.

The processor or a similar concept that includes the functional blocks shown in the drawings and various features of the device with the ability to run the software in conjunction with the appropriate software may be provided by the use of hardware, as well as dedicated hardware. Features, a single dedicated processor, by the processor when they become available, can be provided by a single shared processor, or a plurality of individual processors, some of which can be shared.

In addition, the use of control processor, or similar terms that are presented as a concept is not to be construed quoted exclusive of hardware, with the ability to run the software, and it should be understood as implicitly including a read-only memory (ROM), a random access memory (RAM), and a nonvolatile storage unit for storing the digital signal processor (DSP), hardware, and software, without limitation. Also, other well-known hardware may be included. Also, other well-known hardware may be included.

Components are expressed as the means to perform the functions described in the detailed description of the claims herein, including all types of software, for example, which includes a combination of circuit elements that perform the functions or the firmware/microcode intended to include, and how to perform the function of, for performing the functions mentioned above are combined with appropriate circuitry for executing software. Equal the present invention is defined by the scope of these claims, because a combination of the features offered by various means listed and combined with the claim needs to be understood by any means that can provide the functions herein.

The aforementioned objects, features and advantages will become more apparent through the following detailed description with respect to the accompanying drawings, the technical idea of the present invention with a person of ordinary skill in the art the present invention, accordingly, can be easily carried out. In describing the present invention, a detailed description of known techniques associated with the present invention unnecessarily obscure the gist of the present invention, it is determined that the detailed description thereof will be omitted.

Hereinafter, preferred embodiments of the present invention will be described below in more detail with reference to the accompanying drawings.

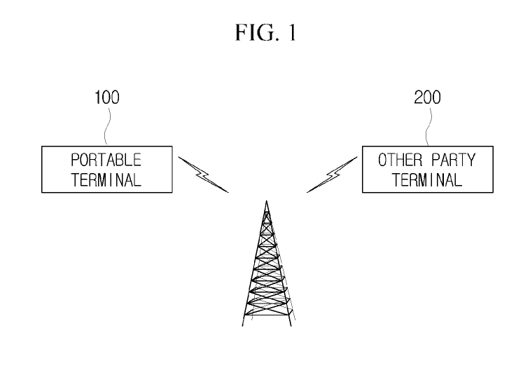

FIG. 1 is a block diagram schematically showing an entire system including a portable terminal 100 and another party terminal 200 according to an embodiment of the present invention.

The portable terminal 100 and the other party terminal 200 described in the specification may include a mobile phone, a smartphone, a laptop computer, a digital broadcast terminal, a personal digital assistant (PDA), a portable multimedia player (PMP), and a navigation system. However, it can be understood by a person skilled in the art that configurations according to embodiments described in the specification may be also applied to a fixed terminal such as a digital television and a desktop computer, except that it is available only to the portable terminal 100.

Referring to FIG. 1, the portable terminal 100 and the other party terminal 200 according to an embodiment of the present invention may transmit and receive a voice signal through a base station.

The base station (BS) may refer to an access point (AP), a radio access station (RAS), a Node B, a base transceiver station (BTS), a mobile multihop relay (MMR)-BS, which may include all or some of functions of the AP, RAS, Node B, BTS, and MMR-BS.

The portable terminal 100 may connect to the base station over a mobile communication network and receive a voice signal transmitted from the other party terminal 200, from the base station.

Likewise, the other party terminal 200 may also connect to the base station over a mobile communication network and receive a voice signal transmitted from the portable terminal 100, from the base station.

In addition, the portable terminal 100 according to an embodiment of the present invention may extract a function control command from the received voice signal, perform a function of the portable terminal corresponding to the function control command, generate a transmission interface for transmitting the function performance result to the other party terminal, and output the transmission interface if a predetermined user operation is detected.

In addition, the portable terminal 100 according to an embodiment of the present invention may receive a user input for the output interface and transmit the function performance result in response to the user input.

The user operation according to an embodiment of the present invention may be detected by at least one illumination sensor or at least one motion sensor.

The function performance result may include at least one of a contact search result, a current location search result, a schedule search result, and a file search result.

The other party terminal 200 may include the same configuration as the portable terminal 100.

Furthermore, the other party terminal 200 may transmit a voice signal including the above-described function control command, receive a function performance result of the other party terminal corresponding to the function control command, generate an alarm interface based on the function performance result, and output the alarm interface if the predetermined user operation is detected.

The other party terminal 200 may execute a function of the other party terminal 200 using the function performance result according to the user input for the alarm interface.

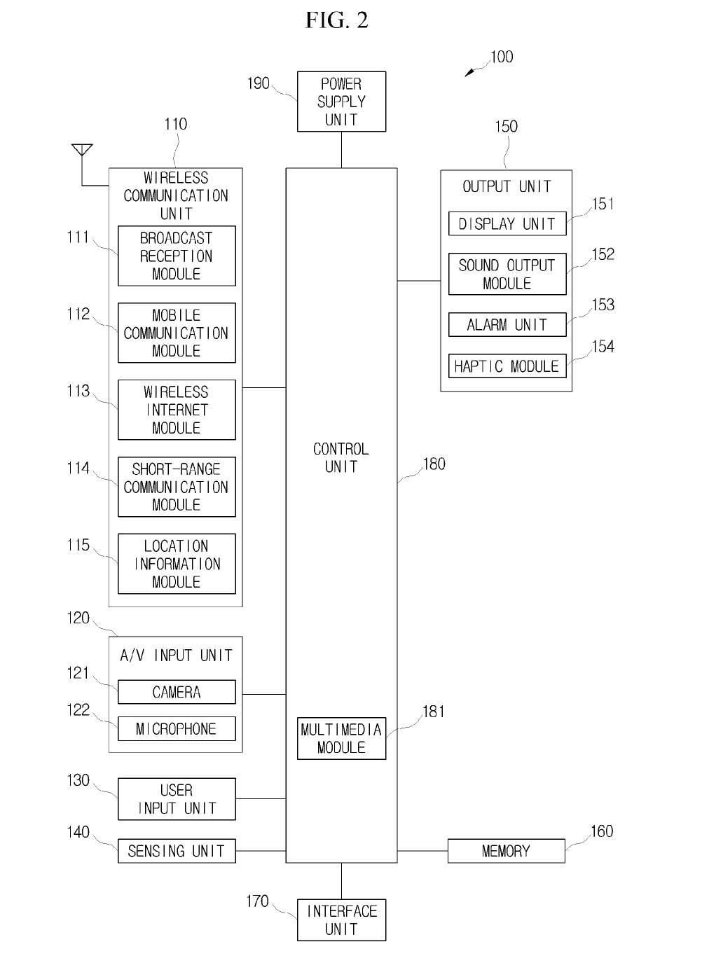

Next, a structure of the portable terminal 100 according to an embodiment of the present invention will be described with reference to FIG. 2.

The portable terminal 100 may be connected with the other party terminal 200 over a mobile communication network or wireless network, and the terminals may have the same configuration. Accordingly, an embodiment of the present invention mainly describes the configuration of the portable terminal 100.

FIG. 2 is a block diagram of the portable terminal 100 according to an embodiment of the present invention.

The portable terminal 100 may include a wireless communication unit 110, an audio/video (A/V) input unit 120, a user input unit 130, a sensing unit 140, an output unit 150, a storage unit 160, an interface unit 170, a control unit 180, and a power supply unit 190. The elements shown in FIG. 1 are not essential, such that the portable terminal may be implemented to have more or less elements.

The wireless communication unit 110 may include one or more modules capable of wireless communication between the portable terminal 100 and a wireless communication system or between the portable terminal 100 and a network in which the portable terminal 100 is located. For example, the wireless communication unit 110 may include a broadcast reception module 111, a mobile communication module 112, a wireless Internet module 113, a short distance communication module 114, and a location information module 115.

The broadcast reception module 111 receives a broadcast signal and/or broadcast-related information from an external broadcast management server over a broadcast channel.

The broadcast signal and/or broadcast-related information received through the broadcast reception module 111 may be stored in the storage unit 160.

The mobile communication module 112 communicates a wireless signal with at least one of a base station, an external terminal, and a server over a mobile communication network. The wireless signal may include a voice call signal, a video call signal, or various types of data according to text and/or multimedia message transmission and/or reception.

The wireless Internet module 113 may support wireless Internet access for the portable terminal and may be internally or externally coupled to the portable terminal 100. Examples of the wireless Internet access technique implemented may include a Wireless LAN (WLAN; Wi-Fi), Wireless broadband (Wibro), World Interoperability for Microwave Access (Wimax), or High Speed Downlink Packet Access (HSDPA).

The short-range communication module 114 is a module for supporting short range communications. Some examples of short-range communication technology include Bluetooth™, Radio Frequency Identification (RFID), Infrared Data Association (IrDA), Ultra-WideBand (UWB), and ZigBee™.

The location information module 115 is a module for checking or acquiring a location (or position) of the portable terminal. A representative example thereof is a global positioning system (GPS) module.

Referring to FIG. 2, the A/V input unit 120 is configured to receive an audio or video signal and may include a camera 121 and a microphone 122. The camera 121 processes an image frame of a still picture or video obtained by an image sensor in a video call mode or image capturing mode. The processed image frame may be displayed on a display unit 151.

The image frame processed by the camera 121 may be stored in the storage unit 160 or transmitted to the outside via the wireless communication unit 110. Two or more cameras 121 may be provided according to a use environment.

The microphone 122 may receive an external sound signal in a phone call mode, a recording mode, and a voice recognition mode to process the external sound signal into voice data.

The user input unit 130 generates input data used for a user to control an operation of a terminal. The user input unit 130 may include a keypad, a dome switch, a touch pad (e.g., a capacitive type or a pressure type), a jog wheel, or a jog switch.

Authentication information may be input through the user input unit 130, and input pattern data may be generated while the authentication information is input.

The sensing unit 140 senses a current status (or state) of the portable terminal 100, such as an opened or closed state of the portable terminal 100, a location of the portable terminal 100, the presence or absence of user contact with the portable terminal 100, the orientation of the portable terminal 100, and an acceleration and deceleration movement of the portable terminal 100, to generate a sensing signal for controlling the operation of the portable terminal 100. For example, when the portable terminal 100 is implemented as a slide type mobile phone, the sensing unit 140 may sense whether the slide phone is open or closed. In addition, the sensing unit 140 can sense whether the power supply unit 190 supplies power or whether the interface unit 170 is coupled with an external device. The sensing unit 140 may include a proximity sensor 141.

In addition, the sensing unit 140 may include, for example, an altitude sensor, an acceleration sensor, a gyro sensor, an atmospheric pressure sensor, etc.

The output unit 150 is intended to generate an output related to visual, auditory, and tactile senses, and may include a display unit 151, a sound output module 152, an alarm unit 153, and a haptic module 154.

The display unit 151 displays (outputs) information processed by the portable terminal 100. For example, when the portable terminal is in a phone call mode, the display unit 151 displays a user interface (UI) or graphic user interface (GUI), which is associated with the call. When the portable terminal 100 is in a video call mode or image capturing mode, the display unit 151 may display a captured image and/or received image, a UI, or a GUI.

The display unit 151 may include at least one of a Liquid Crystal Display (LCD), a Thin Film Transistor-LCD (TFT-LCD), an Organic Light Emitting Diode (OLED) display, a flexible display, or a three-dimensional (3D) display.

When the display unit 151 and a sensor for sensing a touch operation (hereinafter referred to as a “touch sensor”) constitute a mutual layered structure, the display unit 151 may be used as an input device as well as an output device. For example, the touch sensor may be formed as a touch film, a touch sheet, or a touch pad.

The touch sensor may be configured to convert a change in the pressure applied to a particular portion of the display unit 151 or a change in capacitance generated at a particular portion of the display unit 151 into an electrical input signal. The touch sensor may be configured to detect a touch pressure in addition to a touched position or area.

When a touch input is made on the touch sensor, a signal or signals corresponding to the touch input is sent to a touch controller. The touch controller processes the signal and then transmits corresponding data to the control unit 180. Thus the control unit 180 may determine which area of the display unit 151 is touched.

The sound output module 152 may output audio data received from the wireless communication unit 110 or stored in the storage unit 160 in a call signal reception mode, a phone call mode, a recording mode, a voice recognition mode, and a broadcast reception mode. The sound output module 152 may output a sound signal related to a particular function performed by the portable terminal 100, such as a call signal reception sound and a message reception sound. The sound output module 152 may include a receiver, a speaker, a buzzer, and so on.

The alarm unit 153 outputs a signal for alarming occurrence of an event in the portable terminal 100. Examples of the event occurred in the portable terminal may include reception of a call signal, reception of a message, input of a key signal, and input of a touch. The alarm unit 153 may output another form of signal other than a video or audio signal, for example, a signal for alarming occurrence of an event using vibration. The video or audio signal may be output through the display unit 151 or the voice output module 152. Thus the display unit 151 and the voice output module 152 may be considered as a portion of the alarm unit 153.

The haptic module 154 generates various haptic effects that a user may feel. A representative example of the haptic effects generated by the haptic module 154 is vibration. The strength and pattern of the vibration generated by the haptic module 154 are controllable. For example, different vibrations may be output synthetically and sequentially.

The storage unit 160 may store a program for operating the control unit 180, and may temporarily store input/output data (for example, a phonebook, a message, a still image, and a video). The storage unit 160 may store data regarding various patterns of vibration and sound that are output when a touch is input to the touch screen.

The storage unit 160 include at least one type of storage medium including a flash memory, a hard disk, a multimedia card, a card memory (e.g., SD or DX), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk. The portable terminal 100 may cooperate with a web storage device that performs the storage function of the storage unit 160 over the Internet.

The interface unit 170 may function as a communication channel to an external device connected to the portable terminal 100. The interface unit 170 is configured to receive data or power from the external device to transmit the received data or power to each element in the portable terminal 100 or receive data from the portable terminal 100 to transmit the data to the external device. For example, the interface unit 170 may include a wired/wireless headset port, an external charger port, a wired/wireless data port, a memory card port, a portion connecting to a device having an identification module, an audio input/output (I/O) port, a video I/O port, or an earphone port.

The identification module is a chip for storing various information used to authenticate a usage authority of the portable terminal 100, which may include a user identity module (UIM), a subscriber identity module (SIM), or a universal subscriber identity module (USIM). A device having the identification module (hereinafter referred to as an “identification device”) may be formed as a smart card. Accordingly, the identification device may be connected with the portable terminal 100 via a port.

When the portable terminal 100 is connected with an external cradle, the interface unit 170 may serve as a passage for supplying power from the cradle to the portable terminal 100 or a passage for delivering various command signals input from the cradle by the user to the portable terminal 100. The various command signals or power input or supplied from the cradle may operate as signals for indicating that the terminal device 100 has been exactly mounted on the cradle.

The control unit 180 typically controls overall operations of the portable terminal. For example, the control unit 180 performs relevant control and processing associated with a voice call, a data communication, and a video call. In addition, the control unit 180 may include a multimedia module 181 for reproducing (or playing back) multimedia data. The multimedia module 181 may be implemented within the control unit 180 or implemented independently of the control unit 180.

The control unit 180 may perform pattern recognition processing to recognize a handwriting input or a picture drawing input made on the touch screen as a character or image. The control unit 180 may generate input pattern data through the pattern recognition processing.

The power supply unit 190 receives external power or internal power to supply appropriate power required to operate respective elements under the control of the control unit 180.

In an embodiment of the present invention, the control unit 180 may receive a voice signal transmitted from the other party terminal 200 through the wireless communication unit 110. The control unit 180 may acquire a control command from the received voice signal and perform a terminal function operation according to the control command.

The control unit 180 may determine a timing of displaying a performance result based on a user operation detected through the sensing unit 140 and display a transmission interface for transmitting the performance result at the display timing. The transmission interface may include a control icon for checking the transmission of the performance result.

A functional operation of the portable terminal 100 will be described in more detail.

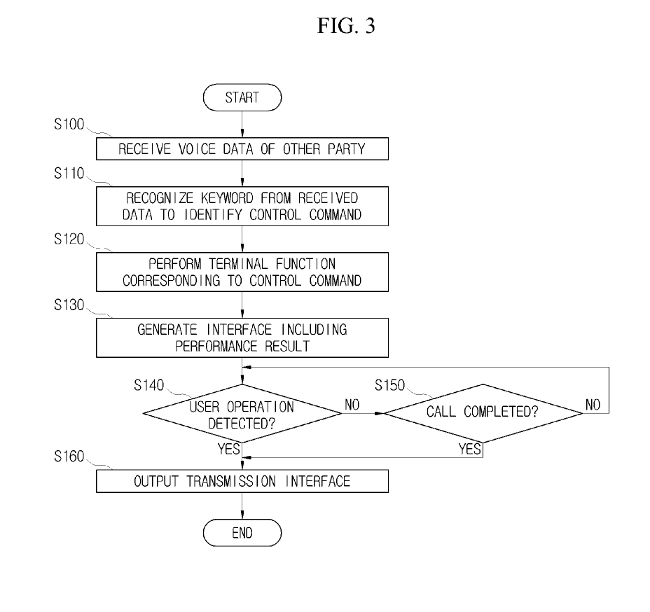

FIG. 3 is a flowchart illustrating an operating method of the portable terminal 100 according to an embodiment of the present invention.

Referring to FIG. 3, first, the portable terminal 100 receives voice data from the other party terminal 200 in step S100.

The control unit 180 of the portable terminal 100 may receive a voice signal transmitted from the other party terminal 200, through the wireless communication unit 110. The received voice signal may include a voice of the other party and include at least one control command. The transmitted or received voice signal may be temporarily stored in the storage unit (e.g., memory) 160 so as to be processed by the control unit 180.

The portable terminal 100 recognizes a keyword from the voice data received from the other party terminal 200 and identifies the control command in step S110.

For example, the control unit 180 extracts predetermined keywords from transmission and reception voices that stored in the memory 160. In this case, the control unit 180 may determine whether the predetermined keyword is included in the reception voices stored from a certain time before the present time. The certain time may be set based on the statistics of voice recognition and storage or randomly set by a user.

Keywords corresponding to the control command may be different depending on functions performed by a terminal.

For example, keywords corresponding to a control command of a contact function may include “contact,” “phone number,” “phone,” “number,” and “address.” In addition, keywords corresponding to a control command of a search function may include “you know,” “what,” “let me know,” etc. Keywords corresponding to a location search function may include “address,” “place,” “location,” “where,” etc. Keywords corresponding to a schedule function may include “schedule,” “date,” “when,” etc. Keywords corresponding to a file management function may include “file,” “photo,” “document,” etc.

The control unit 180 of the portable terminal 100 may extract the control command from a transmission voice accepted through the microphone 121, as well as the reception voice. In this case, the interface according to an embodiment of the present invention may be provided even by a voice command of a user corresponding to a request of the other party.

For example, keywords that can be extracted from the transmission voice corresponding to the search function may include “check,” “report,” “find,” “moment,” “briefly,” etc. In addition, keywords corresponding to the location search function may include “si,” “do,” “dong,” “building,” etc. keywords that can be extracted from the transmission voice corresponding to the schedule search function may include “this week,” “next week,” “week after next week,” “month,” “day,” “day of week,” etc.

The keywords may be classified into a higher keyword and a lower keyword.

The control unit 180 may identify the control command by recognizing the higher keyword and then extracting the lower keyword.

In addition, the control unit 180 may extract the higher keyword from a voice signal received from the other party terminal 200 and extract the lower keyword from a voice signal inputted to the portable terminal 100 through the microphone 121. For example, when a keyword of “know the number of ‘A’?” is received from the other party, the control unit 180 may extract the keyword as a higher keyword. If a keyword of “wait a minute” is received from a user in response thereto, the control unit 180 may acquire a contact search command of “A” as the control command. In this case, it is advantageous that the control command may be performed according to a user's attention.

Subsequently, the portable terminal 100 perform a terminal function corresponding to the control command in step S120.

The terminal function may be performed under the control of the control unit 180. The control unit 180 may search the memory 160 or the Internet network for necessary information on the basis of the identified control command to output the search result.

For example, the control unit 180 may perform a contact search function according to the control command to output the search result. The search result may include a contact, a phone number, a phone, a number, and an address of a specific person.

In addition, the control unit 180 may perform a location search function according to the control command to output the search result. The search result may include GPS information, address information, or surrounding information about a location of the portable terminal 100.

In addition, the control unit 180 may perform a schedule search function according to the control command to output the search result. The search result may include schedule information corresponding to a date, a day of week, or time included in the control command.

In addition, the control unit 180 may perform a file search function according to the control command to output the search result. The search result may include file information corresponding to a stored date, day of week, time, or file name included in the control command. For example, the file information may include information about a photo, document, or music file.

Subsequently, the portable terminal 100 generates an interface including the performance result in step S130.

The control unit 180 may generate a transmission interface including the performance result according to the control command. The transmission interface may include a menu indicating whether to transmit the performance result to the other party terminal 200. The user may select whether to transmit the search result to the other party terminal 200 through a user input on the transmission interface.

Subsequently, the portable terminal 100 determines whether a predetermined user operation is detected in step S140.

The control unit 180 may determine whether the predetermined user operation is detected on the basis of the sensing information sensed by the sensing unit 140. Examples of the sensing unit 140 for detecting the user operation may include various sensors such as a proximity sensor, a gyro sensor, a geomagnetic sensor, and an acceleration sensor.

The user operation may include at least one of overall operations that are performed to control and transmit a corresponding function after the user receives a function control request from the other party. When the other party requests a phone number of a specific person while talking on the phone, the user may naturally perform operations required to search for and transmit the phone number. In this case, the control unit 180 may predetermine the operations and when the operations are detected, output a transmission interface including a result of the previously performed search. This allow the user to skip a terminal manipulation process for performing the function and send the search result with only a simple input.

As an example, the control unit 180 may detect the user operation using a proximity sensor or proximity illumination sensor included in the sensing unit 140. The user may take the portable terminal 100 from his/her ear to control the function while talking on the phone. In this case, the control unit 180 may sense that the user is far from a close proximity state with respect to the portable terminal 100 to detect it as the predetermined user operation.

Furthermore, as an example, the control unit 180 may detect the user operation using an acceleration sensor included in the sensing unit 140. The acceleration sensor is a sensor for measuring an acceleration and a direction of the acceleration when a motion occurs. Specifically, the acceleration sensor outputs a sensing value corresponding to a gravitational acceleration changing according to a slope of a device having the acceleration sensor attached thereto. In order to perform manipulation while talking on the phone, the user may lower the portable terminal 100, or raise the portable terminal 100 in a speaker phone mode.

Accordingly, the output value that is sensed by each acceleration sensor changes when the portable terminal 100 is lowered or raised. The control unit 180 calculates a pitch angle and a role angle using the output value sensed by each acceleration sensor. Thus, the control unit 180 may detect the user operation based on changes in the pitch angle and the role angle which are sensed by each acceleration sensor.

Also, the control unit 180 may detect the user operation using a gyro sensor or geomagnetic sensor in addition to the acceleration sensor included in the sensing unit 140. The gyro sensor is a sensor that measures a Coriolis force applied in a velocity direction when a rotational motion occurs and detects an angular velocity. According to a value measured by the gyro sensor, since a direction in which the portable terminal 100 is rotated may be detected, the control unit 108 may sense the user operation for manipulating the portable terminal 100. The geomagnetic sensor is a sensor for sensing an azimuth using a two- or three-axis flux gate. The geomagnetic sensor outputs an electric signal corresponding to change in geomagnetism due to location movement. The control unit 180 may calculate a yaw angle using a value output from the geomagnetic sensor. Thus the control unit 180 may determine various operations such as a location area and direction of the portable terminal 100 according to change in the calculated yaw angle and detect the predetermined user operation.

In addition, the control unit 180 may recognize a user captured by the camera 121 to detect the user operation. When the user stares at the portable terminal 100 to perform a function, the control unit 180 may recognize an eye of the user from an imaged captured by the camera 121 to detect the user operation.

The user operation detection configuration and the sensing method of the control unit 180 using the above-described sensing unit 130 may be applied to the portable terminal 100 separately or in a combination.

When the user operation is not detected, the portable terminal 100 determines whether the phone call is completed in step S150.

Subsequently, when the predetermined user operation is detected or the phone call is completed, the portable terminal 100 outputs a transmission interface in step S160.

As described above, the transmission interface may include the function performance result according to the control command of the control unit 180. For example, the transmission interface may include at least one of a contact function performance result, Internet search function performance result, a location search function performance result, and a schedule function performance result.

In addition, the transmission interface may include a transmission menu for selecting whether or not to perform transmission. The user may transmit the search result or not. In particular, when the function performance result includes security information, the user may select non-transmission in a transmission menu.

The user may select whether to perform transmission through the user input on the transmission interface. For example, the user input may be input through the user input unit 130. In addition, the user may also select whether to perform transmission to the transmission interface by a voice input through the microphone.

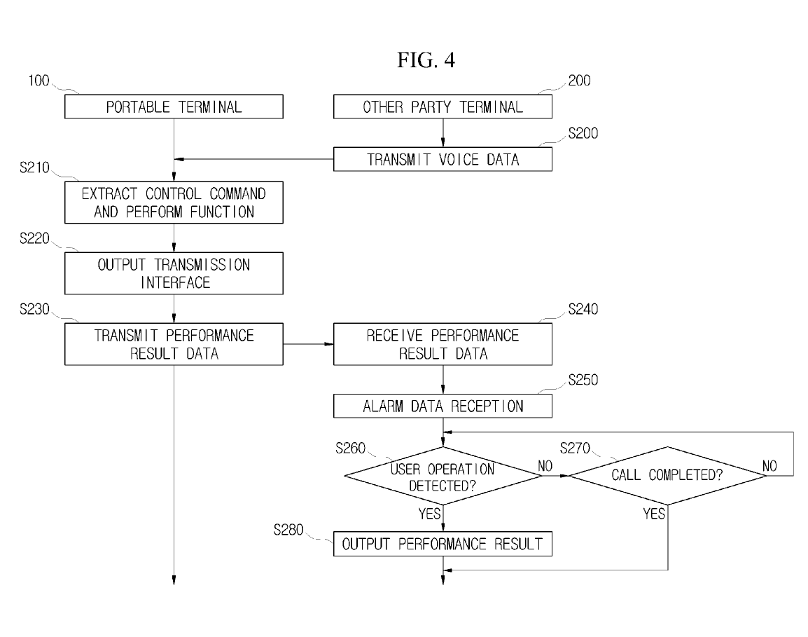

FIG. 4 is a ladder diagram illustrating an operation between a portable terminal 100 and another part's terminal 200 according to another embodiment of the present invention.

Referring to FIG. 4, first, the other party terminal 200 transmits voice data in step S200. The voice data may include a control command.

When the voice data is received, the portable terminal 100 extracts the control instruction and perform a function corresponding to the control instruction in step S210. The portable terminal 100 outputs a transmission interface according to the function performance result in step S220. The detailed operation method is the same as described above.

Subsequently, the portable terminal 100 transmits the performance result data to the other party terminal 200 in step S230. The portable terminal 100 may transmit the performance result data through the wireless communication unit 110.

Subsequently, the portable terminal 200 receives the performance result data in step S240.

When the performance result is received, the other party terminal 200 performs data reception notification in step S250. For example, the data reception notification may vary depending on a type of the received performance result data. This will be described below.

Subsequently, the other party terminal 200 determines whether the predetermined user operation is detected in step S260.

Likewise, the control unit of the other party terminal 200 may determine whether the predetermined user operation is detected based on the sensing information sensed by the sensing unit. Examples of the sensing unit 140 for detecting the user operation on the other party terminal 200 may include various sensors such as a proximity sensor, a gyro sensor, a geomagnetic sensor, and an acceleration sensor.

For example, the user operation on the other party terminal 200 may denote a user operation on the other party terminal 200 to check the received performance result after the data reception notification is performed.

Accordingly, the user operation predetermined in the other party terminal 200 may include at least one of the overall operations that are performed to check the received control result. When the result reception notification is performed while talking on the phone, the user may naturally perform operations required for the check. In this case, the control unit 180 of the other party terminal 200 may predetermine the operations and when the operations are detected, may output a result of the search performed previously and execute a corresponding function. Thus a user of the other party terminal 200 may skip a terminal manipulation process for performing a function according to the result reception check and result.

As such, the user operation on the other party terminal 200 may be detected according to the sensing information sensed from the sensing unit, identically to the portable terminal 100.

When the user operation is not detected, the portable terminal 200 determines whether the phone call is completed in step S270.

Subsequently, when the predetermined user operation is detected or the phone call is completed, the portable terminal 200 outputs the performance result in step S280. The user of the other party terminal 200 may check the performance result, and operate a function of the other party terminal 200 according to the performance result.

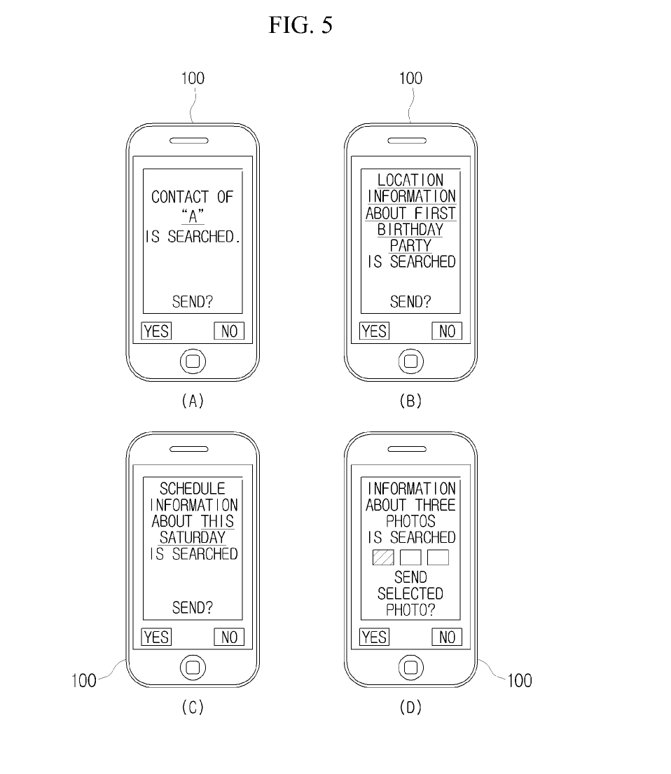

FIG. 5 shows transmission interfaces output to a portable terminal 100 according to an embodiment of the present invention.

Each transmission interface may include a various function performance result according to a control command and include a selection menu for selecting whether to perform transmission.

As shown in FIG. 5A, the transmission interface may include a contact research result. The control unit 180 may recognize keywords of “number of ‘A’” and “know” from the other party voice signal of “You know number of ‘A’?” and execute a contact function. In addition, the control unit 180 may recognize “number of ‘A’” and “check” from the other party voice signal of “Number of ‘A’? Just a moment, I'll check” of the user of the portable terminal 100. In addition, the control unit 180 may generate a transmission interface including a “number of ‘A’” and output the transmission interface through the display unit 151 when the user operation is detected.

As shown in FIG. 5B, the transmission interface may include a contact research result. The control unit 180 may recognize a keyword of “where” from the other party voice signal of “you will hold your kid's first birthday party? Where?” and execute a search function of the memory 160 with respect to “a place of first birthday party.” In addition, the control unit 180 may recognize “place” from a transmission voice signal of “Yes, yuthface building, sampyeong-dong, bundang-gu, seongnam-si, gyeonggi-do” of the user of the portable terminal 100 and perform a map search. In addition, the control unit 180 may generate a transmission interface including the location search result of the first birthday party place and output the transmission interface through the display unit 151 when the user operation is detected.

As shown in FIG. 5C, the transmission interface may include a schedule function performance result. The control unit 180 may recognize a keyword of “you have time?” from the other party voice signal of “I'll hold a birthday party. You have time this Saturday?” and execute a schedule search function on “Saturday” corresponding thereto. In addition, the control unit 180 may recognize a keyword of “schedule” from a transmission voice signal of “This Saturday? I'll check my schedule.”, execute a schedule function, and execute a schedule search function on “this Saturday” corresponding thereto. In addition, the control unit 180 may generate a transmission interface including a result of the schedule search on the “this Saturday” and output the transmission interface through the display unit 151 when the user operation is detected.

As shown in FIG. 5D, the transmission interface may include a file search result. The control unit 180 may recognize a keyword of “photo” from the other party voice signal of “Send me a photo of us together.” and execute a photo file search result corresponding thereto. In addition, the control unit 180 may recognize “photo” from the transmission voice signal of “photo? Just a minute” of the user of the portable terminal 100 and execute a photo file search function. The control unit 180 may generate a transmission interface including a photo file search result and output the transmission interface through the display unit 151 when the user operation is detected. In this case, the photo file search result may include a plurality of photos. Thus the control unit 180 may output a transmission interface including a photo selection menu in order to select any of the plurality of photo.

According to this embodiment, it is possible for the user to perform a function of the portable terminal 100 which is required by the other party without separate manipulation and also conveniently select whether the transmission is performed by outputting the transmission interface at an appropriate time.

According to an embodiment of the present invention, the function performance operation according to the other party control command may be also performed after detecting the user operation. If the function operation is performed in advance, it is advantageously possible to reduce output delay when the user operation is detected. If the function operation is performed after the user operation is detected, it is also advantageously to reduce power consumption and a calculation amount by disallowing an unnecessary search function.

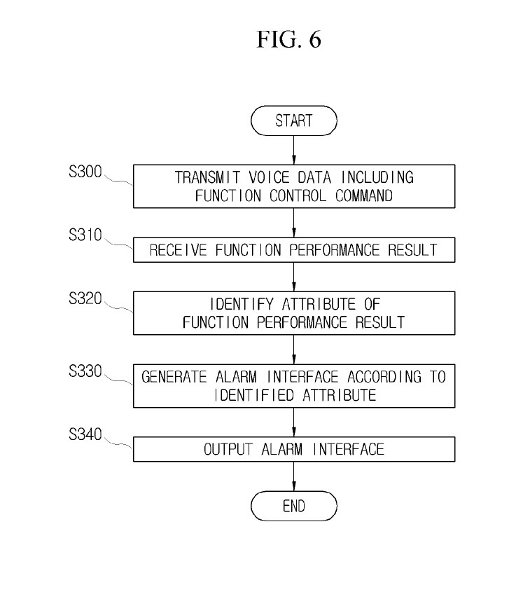

FIG. 6 is a flowchart illustrating an operation of a portable terminal 100 according to another embodiment of the present invention.

In this embodiment of the present invention, the portable terminal 100 and the other party terminal 200 are described separately, but may perform the same operations. Accordingly, the portable terminal 100 may transmit a voice signal including a control command to the other party terminal 200 and receive the function control result. In FIG. 6, operations of the portable terminal 100 that has received the function control result will be mainly described, but the operations may be performed by the other party terminal 200.

Referring to FIG. 6, the portable terminal 100 transmits voice data including a function control command in step S300 and receives a function performance result corresponding thereto in step 310.

Subsequently, the portable terminal 100 identifies an attribute of the function performance result in step S320.

The control unit 180 may identify the attribute from a format of function performance result data received through the wireless communication unit 110. For example, when the function performance result data indicates contact information, the control unit 180 may identify the data as having a contact attribute. When the function performance result data indicates location information, the control unit 180 may identify the data as having a location information attribute. When the function performance result data indicates schedule information, the control unit 180 may identify the data as having a location information attribute. When the function performance result data indicates location information, the control unit 180 may identify the data as having a file attribute.

Subsequently, the portable terminal 100 generates an alarm interface according to an attribute of the function performance result in step S330 and outputs the generated alarm interface according to detection of the user operation in step S340.

The alarm interface may include an interface for controlling the portable terminal 100 according to the function performance result. Accordingly, the alarm interface may vary depending on the function performance result. The user may execute a function of the portable terminal 100 corresponding to the data attribute without complicated manipulation while checking the function performance result from the portable terminal 100.

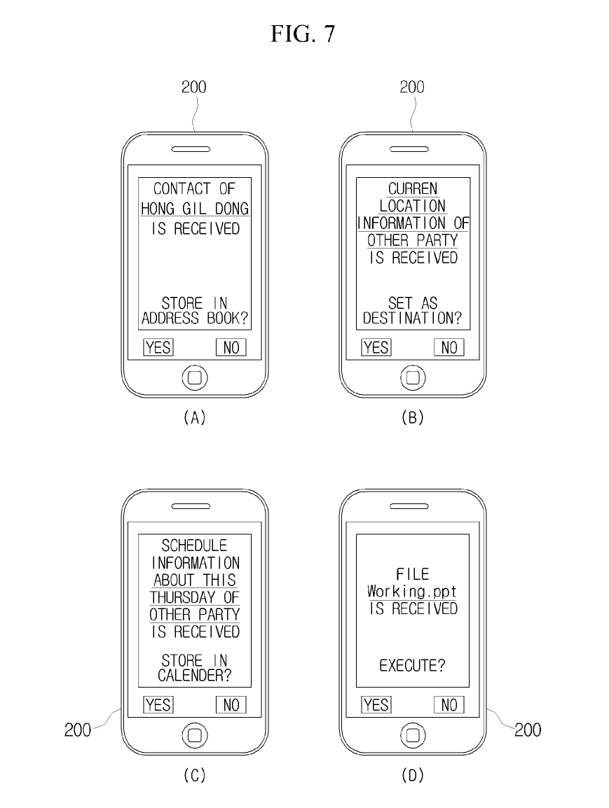

FIG. 7 is a diagram illustrating the alarm interface.

Referring to FIG. 7A, the alarm interface may include the received contact search result data. The alarm interface may include a selection interface indicating whether to perform an address book storage function, corresponding to the contact data format. The user may execute the address book storage function of the received contact search result with just a simple user input on the selection interface.

Referring to FIG. 7B, the alarm interface may include the received location search result data. Then the alarm interface may include a selection interface indicating whether to perform a navigation destination setting function, corresponding to the location information data format. The user may execute the navigation function having the receive location information as a destination with just a simple user input on the selection interface.

Referring to FIG. 7C, the alarm interface may include the received schedule search result data. The alarm interface may include a selection interface indicating whether to perform a calendar storage function, corresponding to the schedule information data format. The user may execute a function for storing the schedule information in a calendar with just a simple user input on the selection interface.

Referring to FIG. 7D, the alarm interface may include the received file search result data. The alarm interface may include a selection interface indicating whether to execute a file, corresponding to the data format of the file. The user may execute the received file with just a simple user input on the selection interface. Though not shown, when a photo is included in the file, the selection interface may include a function of selectively store the receive photos.

Also, the method according to an embodiment of the present invention may be implemented by a program to be executed in a computer and then stored in a computer readable recording medium. Examples of the computer readable recording medium include read-only memory (ROM), random-access memory (RAM), CD-ROMs, magnetic tapes, floppy disks, optical data storage devices, and carrier waves (such as data transmission through the Internet).

The computer readable recording medium can also be distributed over network-coupled computer systems so that the computer readable code is stored and executed in a distributed fashion. Also, functional programs, codes, and code segments for realizing the method of receiving broadcasting signals can be easily construed by programmers skilled in the art to which the present invention pertains.

According to an embodiment of the present invention, it is possible to perform a specific function with just recognition of the voice of the other party, and also conveniently transmit a function performance result drawn from the voice recognition with just one check by outputting the function performance result at one appropriate time according to a user operation or call status.

Furthermore, it is also possible for the user to conveniently check the performance result and perform the terminal function corresponding to the performance result by outputting the alarm interface based on the function performance result received from the other party terminal at one appropriate time according to a user operation or call status.

While this invention has been particularly shown and described with reference to preferred embodiments thereof, it will be understood by those skilled in the art that various changes in form and details may be made therein without departing from the spirit and scope of the invention as defined by the appended claims, and also the various changes should not be understood departing from the spirit and scope of the invention.

What is claimed is:

1. An operating method of a portable terminal, comprising:
receiving a voice signal from another party terminal;
extracting a function control command from the voice signal;
performing a function of the portable terminal corresponding to the function control command;
generating an interface for transmitting a result of the function performance to the other party terminal; and
outputting the interface when a predetermined user operation is detected.

2. The operating method of claim 1, further comprising:
receiving a user input on the output interface; and
transmitting the function performance result corresponding to the user input.

3. The operating method of claim 1, wherein the user operation is detected by at least one illumination sensor or at least one motion sensor.

4. The operating method of claim 1, wherein the function performance result includes at least one of a contact search result, a current location search result, a schedule search result, and a file search result.

5. A terminal for communicating a voice signal with another party terminal, the terminal comprising:
a communication unit configured to receive the voice signal from the other party terminal;
a control unit configured to extract a function control command from the voice signal, perform a function of the terminal corresponding to the function control command, and generate an interface for transmitting a result of the function performance to the other party terminal; and
a display unit configured to output the interface when a predetermined user operation is detected.

6. The terminal of claim 5, further comprising a user input unit configured to receive a user input on the output interface,
wherein the communication unit transmits the function performance result corresponding to the user input.

7. The terminal of claim 5, further comprising at least one illumination sensor or at least one motion sensor configured to detect the user operation.

8. The terminal of claim 5, wherein the function performance result includes at least one of a contact search result, a current location search result, a schedule search result, and a file search result.

9. An operating method of a portable terminal, comprising:
transmitting a voice signal including a function control command;
receiving a function performance result of another party terminal corresponding to the function control command;
generating an alarm interface based on the function performance result; and
outputting the alarm interface when a predetermined user operation is detected.
